(19) United States
(12) Patent Application Publication
(10) Pub. No.: US 2011/0158831 A1
(43) Pub. Date: Jun. 30, 2011

(54) FAN AND MOTOR THEREOF

(76) Inventors: Shin-Ming HUANG, Taoyuan Hsien (TW); Kun-Chou Lee, Taoyuan Hsien (TW); Hung-Yi Liang, Taoyuan Hsien (TW)

(21) Appl. No.: 12/952,915

(22) Filed: Nov. 23, 2010

(30) Foreign Application Priority Data
Dec. 24, 2009 (CN) 200910215548.7

(51) Int. Cl. F04B 35/04; H02K 21/12

(52) U.S. Cl. 417/410.1; 310/156.43

(57) ABSTRACT

A motor including a bearing structure, a rotor structure, a stator structure and a magnetic body is disclosed. The rotor structure includes a shaft disposed on the bearing structure. The stator structure is disposed corresponding to the rotor structure. The magnetic body is disposed opposite to the shaft and includes a first magnetic element and a second magnetic element. The first magnetic element is disposed around the second magnetic element. A fan including the motor is disclosed as well. The shaft of the fan and the motor thereof are provided with higher axial attraction in operation such that it reduces the abrasion of the shaft and the noise of the motor and the fan.

### CROSS REFERENCE TO RELATED APPLICATIONS

This Non-provisional application claims priority under 35 U.S.C. §119(a) on Patent Application No(s). 200910215548.7, filed in People's Republic of China on Dec. 24, 2009, the entire contents of which are hereby incorporated by reference.

### BACKGROUND OF THE INVENTION

1. Field of Invention

The present invention relates to a fan and a motor thereof and, in particular, to a fan and a motor thereof, whose shaft is provided with higher axial attraction.

2. Related Art

Motors can be applied in a variety of electronic equipments such as fans, optical disk drivers, hard disk drivers, optical devices or color wheels. Generally, a sliding bearing is used in the motor, and the shaft of the motor can move axially along the center of the sliding bearing to generate relative movement with respect to the sliding bearing in certain structure. However, the displacement of the shaft in various degrees may occur in the axial direction in operation in accordance with different disposition angles and use conditions of the motor. It may further cause the abrasion of the shaft and the noise generation of the motor. Consequently, the displacement constraint of the motor in the axial direction is considered to be an effective solution for certain issue.

Conventional methods for constraining the shaft displacement of the motor in the axial direction can not go out of the following three methods. The first method is to dispose a magnetic body respectively on the motor shaft and the base such that downward attraction can be provided for constraining the shaft displacement. However, two magnetic bodies are required in certain method and thereby the cost of production must increase.

The second method is to dispose a magnetic body and a magnetic back yoke on the base of the motor. It provides axial attraction for the shaft by the mutual attraction between the shaft with the magnetic property and the magnetic body. Because the most magnetic lines of the magnetic body form circuits by passing through elements without magnetic property, such as air, in certain method, the magneto resistance of the circuits are higher and thereby weakens the axial attraction provided to the shaft.

The third method is to dispose a magnetic structure on the base of the motor and apply elements with magnetic property inside the motor, such as a magnetic shaft, base or bearing. It can form magnetic circuits with the magnetic lines from one side of the magnetic structure to another by passing through the magnetic elements for increase of the attraction between the shaft and the magnetic structure. However, the shaft and the magnetic structure are respectively disposed in two separated chambers and the gap between the shaft and the magnetic structure is larger. Thus, the axial attraction provided to the shaft is weaker, and it is not effective enough for practical use.

Therefore, a motor and a fan including a shaft provided with higher axial attraction have been desired. They can constrain the displacement of the shaft in the axial direction and thereby reduce the abrasion of the shaft and the noise generation of the motor and the fan.

### SUMMARY OF THE INVENTION

In view of the foregoing, the present invention provides a motor and a fan including a shaft provided with higher axial attraction. They can constrain the displacement of the shaft in the axial direction and thereby reduce the abrasion of the shaft and the noise generation of the motor and the fan.

To achieve the above, the present invention provides a motor including a bearing structure, a rotor structure, a stator structure and a magnetic body. The rotor structure includes a shaft disposed on the bearing structure. The stator structure is disposed corresponding to the rotor structure. The rotor structure further includes an iron housing and a hub connected to the iron housing and the hub. The rotor further includes a magnetic band disposed in and connected to the iron housing. The magnetic band is disposed corresponding to the stator structure. The motor further includes a base including a bushing, and the shaft and the bearing structure are disposed in the bushing. The motor further includes a magnetic element connected to the base, and the magnetic body is disposed in the bushing and located at a side of the magnetic element. The magnetic element is plate-shaped or cup-shaped.

In accordance with an embodiment of the present invention, the motor further includes a baffle disposed between the shaft and the magnetic body, and the magnetic body is disposed opposite to the shaft through the baffle. The magnetic body is disposed corresponding to the shaft and includes a first magnetic element and a second magnetic element. The first magnetic element is disposed around the second magnetic element.

In accordance with an embodiment of the present invention, the first magnetic element and the second magnetic element are disposed in concentric or non-concentric.

In accordance with an embodiment of the present invention, the polarities of the first magnetic element and the second magnetic element disposed at the same side are opposite.

In accordance with an embodiment of the present invention, the magnetic element is plate-shaped or cup-shaped.

In accordance with an embodiment of the present invention, the width of the first magnetic element is larger than the diameter of the shaft, or the width of the second magnetic element is 0.4 to 1 times as wide as the diameter of the shaft.

To achieve the above, the present invention provides a fan including the motor, a frame, a stationary blade and a plurality of blades. The blades are disposed around the periphery of the rotor structure. The frame is connected to the base, and the stationary blade is respectively connected to the frame and the base.

In summary, the motor and the fan of the present invention is provided with the magnetic body in the axial direction of the shaft of the motor. The magnetic body includes the first magnetic element and the second magnetic element, and the first magnetic element is disposed around the second magnetic element. Thus, the magnetic lines of the magnetic body form shorter closed paths and provide higher magnetic flux density to pass through the magnetic body and the shaft for providing the shaft and the magnetic body with higher axial attraction. It constrains the displacement of the shaft in the axial direction, and further reduces the abrasion of the shaft and the noise generation of the motor and the fan. In addition, the first magnetic element and the second magnetic element of the motor and the fan in accordance with the present invention, which are disposed at the same side but with opponent polarities, also contribute to the reduction of magnetic leakage because the magnetic lines of the first magnetic element and the second magnetic element can form shorter closed paths and provides higher magnetic flux density. It further reduces the level of magnetic interference to other elements.

### BRIEF DESCRIPTION OF THE DRAWINGS

The invention will become more fully understood from the detailed description and accompanying drawings, which are given for illustration only, and thus are not limitative of the present invention, and wherein:

FIG. 1A and FIG. 1B are respectively a cross-sectional figure and an enlarged figure thereof of a motor in accordance with the first embodiment of the present invention;

FIG. 1C is a schematic figure of the magnetic body in accordance with another aspect of the present invention;

FIG. 2A is a schematic figure of the combination of the first magnetic element and the second magnetic element of the motor 2 shown in FIG. 1B;

FIGS. 2B and 3A to 3D are schematic figures of different aspects of the first magnetic element and the second magnetic element in accordance with the present invention;

FIG. 4A is a schematic figure of the distribution of the magnetic lines between the shaft and the magnetic body of a conventional motor;

FIG. 4B is a schematic figure of the distribution of the magnetic lines between the shaft and the magnetic body of the motor in accordance with the first embodiment of the present invention;

FIG. 5 is a cross-sectional figure of the motor in accordance with the second embodiment of the present invention; and

FIG. 6 is a cross-sectional figure of a fan in accordance with the preferable embodiment of the present invention.

### DETAILED DESCRIPTION OF THE INVENTION

The present invention will be apparent from the following detailed description, which proceeds with reference to the accompanying drawings, wherein the same references relate to the same elements.

### The First Embodiment

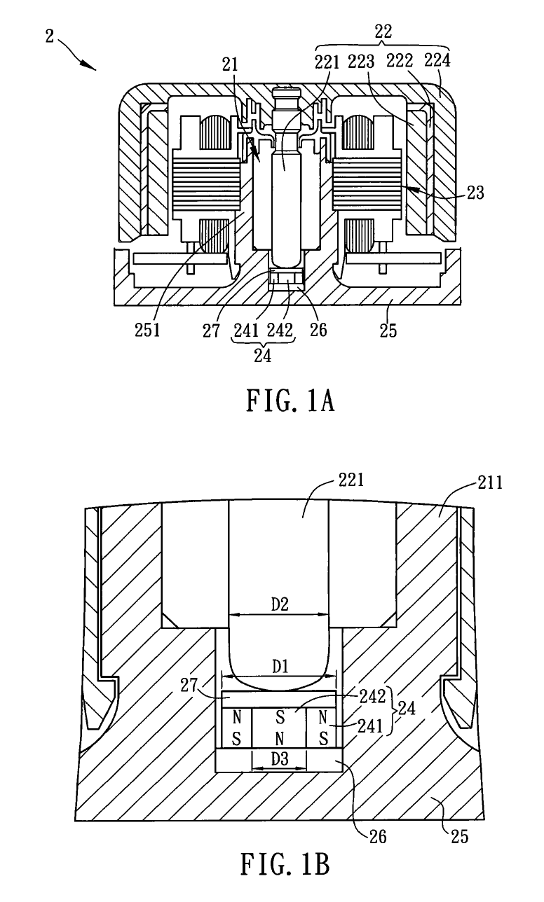

FIG. 1A and FIG. 1B are respectively a cross-sectional figure and an enlarged figure thereof of a motor in accordance with the first embodiment of the present invention. The motor 2 can be an external-rotor motor or an internal-rotor motor. Herein, the external-rotor motor is taken for exemplary description of the present invention.

The motor 2 includes a bearing structure 21, a rotor structure 22, a stator structure 23 and a magnetic body 24. The rotor structure 22 includes an iron housing 222, a magnetic band 223, a hub 224 and a shaft 221 disposed in the bearing structure 221. The shaft 221 can be made of, for example but not limited to, magnetic material or non-magnetic material. The hub 224 is connected to the iron housing 222 and the shaft 221 respectively. The magnetic band 223 is disposed in and connected to the iron housing 222. The hub 224 is connected to the shaft 221 by, for example, mounting, locking or adhesion.

The magnetic band 223 is, for example, a magnetic ring, and is disposed around the internal surface of the iron housing 222. The iron housing 222 is disposed around the internal surface of the hub 224. The magnetic band 224 corresponds to the stator structure 23. The material of each of the magnetic body and the magnetic band includes, for example but not limited to, ferrite, soft ferrite magnet, highly magnetic alloy, magnetic material or a combination thereof.

The stator structure 23 is disposed corresponding to the rotor structure 22. In the present embodiment, the stator structure 23 is disposed corresponding to the magnetic band 223 of the rotor structure 22. The stator structure 23 is not limited to any specific type, and can be made of, for example, coreless coils or coils wired by a plurality of silicon steel plates. The stator structure 23, made of coils wired around silicon steel plates, is taken for exemplary description.

The magnetic body 24 is disposed opposite to the shaft 221, and includes a first magnetic element 241 and a second magnetic element 242. The first magnetic element 241 is disposed around the second magnetic element 242. In other words, if the center of the magnetic body 24 is considered as a reference point, the first magnetic element 241 is disposed as an outer circle and the second magnetic element 242 is disposed in the hollow portion surrounded with the first magnetic element 241. The second magnetic element 242 is directly connected to the first magnetic element 241. In other words, the first magnetic element 241 is connected to the second magnetic element 242 by tight connection.

The motor 2 further includes a base 25 and a magnetic element 26. The base 25 includes a bushing 251, and the shaft 221 and the bearing structure 21 are disposed in the bushing 251. The magnetic element 26 connected to the base 25, and the bearing structure 21 and the stator structure 23 are disposed on the base 25. The magnetic body 24 is disposed in the bushing 251 and located at a side of the magnetic element 26. The magnetic element 24 is disposed above the magnetic element 26.

In the present embodiment, the base 25 and the bushing 251 are, for example, integrally formed as one piece, and the material of the base 25 includes, for example, metal or plastic. The magnetic element 26 is, for example, a magnetic back yoke, and its shape is, for example, plate-shaped or cup-shaped. Herein, the plate-shaped magnetic element 26 is taken for exemplary description.

The motor 2 further includes a baffle 27 disposed between the shaft 221 and the magnetic body 24. The magnetic body 24 is disposed opposite to the shaft 221 through the baffle 27.

In addition, as shown in FIG. 1B, in the present embodiment, the width D1 of the first magnetic element 241 is larger than the diameter D2 of the circular shaft 221, and the width D3 of the second magnetic element 242 is 0.4 to 1 times as wide as the diameter D2 of the shaft 221.

FIG. 1C is a schematic figure of the magnetic body 24a in accordance with another aspect of the present invention. The second magnetic element 242a is also disposed at the hollow portion, but is not connected to the first magnetic element 241a directly. In other words, the first magnetic element 241a is disposed around the second magnetic element 242a by sliding connection, and a gap G is formed between the first magnetic element 241a and the second magnetic element 242a.

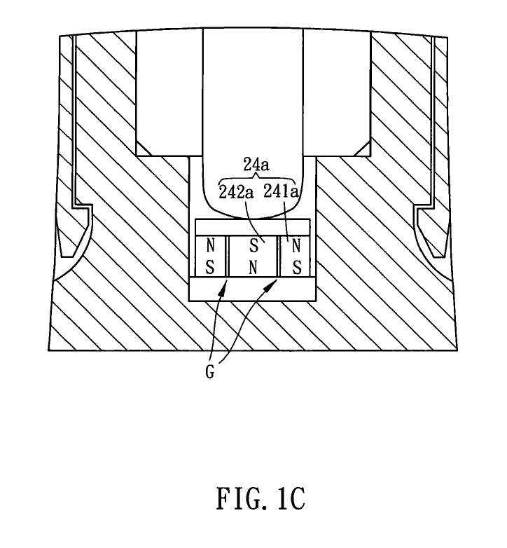

FIG. 2A is a schematic figure of the combination of the first magnetic element 241 and the second magnetic element 242 of the motor 2 shown in FIG. 1. The first magnetic element 241 and the second magnetic element 242 are, for example, two individual elements corresponding to each other and then assemble together. If the first magnetic element 241 and the second magnetic element 242 are connected to each other with tight connection by locking, no gap is formed between them. Alternatively, the first magnetic element 241 and the second magnetic element 242 can be also connected to each other by sliding connection. In other words, the first magnetic element 241 is not connected to the second magnetic element 242 directly. Instead, a gap is formed between the first magnetic element 241 and the second magnetic element 242, and then the gap can be filled with gel to eventually achieve the same effect like the tight connection between the first magnetic element 241 and the second magnetic element 242 does.

The combination type of the first magnetic element 241 and the second magnetic element 242 can be various. The aforementioned two types are only taken for exemplary description, but not to limit the scope of the present invention. Any combination disposing the first magnetic element 241 around the second magnetic element 242 to form the magnetic body 24 can be used. For example, the first magnetic element 241 can be connected to the second magnetic element 242 by adhesion and locking simultaneously.

The polarities of the first magnetic element 241 and the second magnetic element 242 disposed at the same side (either top side or bottom side shown in FIGS. 2A and 2B) are opposite. By way of example, as shown in FIGS. 2A and 2B, the top side of the first magnetic element is N pole, and the top side of the second magnetic element 242 is S pole. To be noted, FIGS. 2A and 2B are taken for exemplary description but not to limit the present invention. Alternatively, the polarities of the first magnetic element 241 and the second magnetic element 242 can be switched. In more detailed, the top side of the first magnetic element 241 can be S pole, and the top part of the second magnetic element 242 can be N pole.

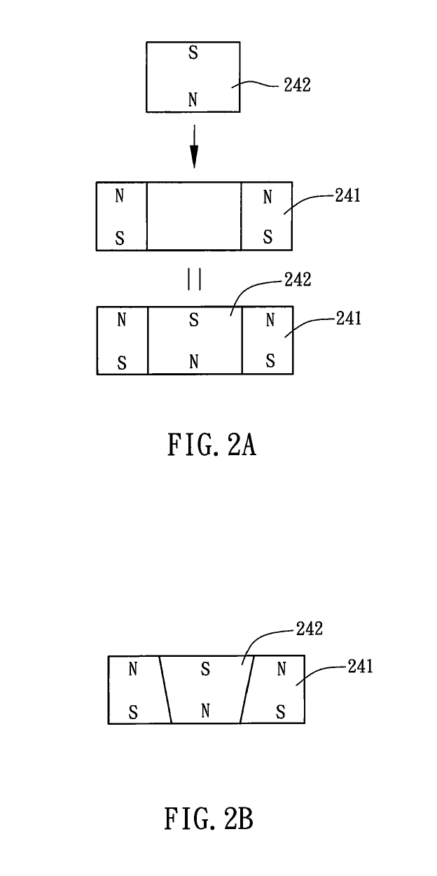

Moreover, the shapes of the first magnetic element 241 and the second magnetic element 242 can be various as well. As shown in FIG. 2A, the vertically cross-sectional shape of the second magnetic element 242 is rectangular; however, as shown in FIG. 2B, the vertically cross-sectional shape of the second magnetic element 242 is ladder-shaped. Otherwise, as shown in FIG. 3A to 3D, the horizontally cross-sectional shape of the second magnetic element 242 is, for example, circular, rectangular or triangular. The first magnetic element 241 is formed in the same shape as that of the second magnetic element 242, or the first magnetic element 241 is formed in a shape different from that of the second magnetic element 242. In other words, the magnetic body 24 can be formed by the combination of the first magnetic element 241 and the second magnetic element 242 with the same or different shapes. The first magnetic element 241 and the second magnetic element 242 can be disposed in concentric or non-concentric. In the present embodiment, the first magnetic element 241 and the second magnetic element 242 are disposed in concentric for exemplary description. To be noted, the dispositions shown in FIGS. 3A and 3D are for exemplary description but not to limit the present invention. Any disposition that the first magnetic element 241 is disposed around the second magnetic element 242 and, meanwhile, the polarities of the first magnetic element 242 and the second magnetic element 242 disposed at the side are opposite can be applied in the present invention. Moreover, either any specific shape of the first magnetic element 241 and the second magnetic element 242 or the formation of the gap between the first magnetic element 241 and the second magnetic element 242 is not required.

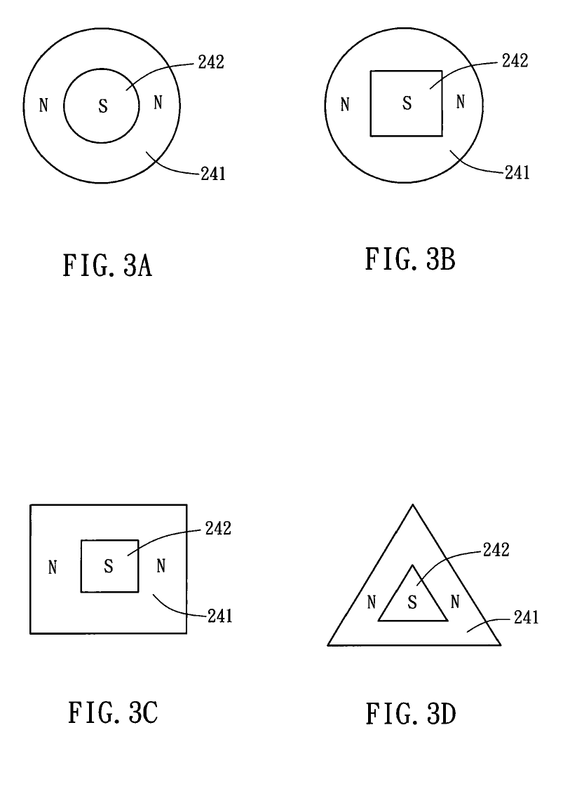

FIG. 4A is a schematic figure of the distribution of the magnetic lines between the shaft and the magnetic body of a conventional motor. The reference number 121 indicates the shaft of the conventional motor 1, the reference number 14 indicates the magnetic body disposed below the shaft 121 and used to generate attraction with the shaft 121, and the reference number 16 indicates the magnetic element disposed below the magnetic body 14. The reference number 17 indicates a baffle used to separate the shaft 121 from the magnetic body 24. To be noted, for describing the present embodiment clearly, only the magnetic body 14, the shaft 121, the magnetic element 16 and the baffle 17 are shown in FIG. 4A instead of all of the elements of the motor 1.

As shown in FIG. 4A, most of the magnetic lines of conventional motor 1 provided with the regular magnetic body 14 are distributed at two sides of the magnetic body 14 near the shaft 121, and only a few magnetic lines are disturbed from the center of the shaft 121 to the magnetic body 14. Thus, the positions where the strongest axial attraction generated by the magnetic forces is occurred are concentrated at the two sides of the magnetic body 14 instead of from the center of the shaft 121 to the magnetic body 14. Therefore, the axial attraction between the shaft 121 and the magnetic body 14 of the motor 1 is not high enough to effectively constrain the displacement of the shaft 121 in the axial direction.

By contrast, FIG. 4B is a schematic figure of the distribution of the magnetic lines between the shaft 221 and the magnetic body 24 of the motor 2 in accordance with the first embodiment of the present invention. To be noted, for describing the present embodiment clearly, only the first magnetic element 241 and the second magnetic element 242 of the magnetic body 24, the shaft 221, the magnetic body 26 and the baffle 27 are shown in FIG. 4B instead of all of the elements of the motor 2.

As shown in FIG. 4B, the magnetic lines of the magnetic body 24 form shorter closed paths and provide higher magnetic flux density to pass through the first magnetic element 241, the second magnetic element 242 and the shaft 221 by the disposition of the magnetic body 24, which is formed by the first magnetic element 241 and the second magnetic element 242 disposed at the same side but with opponent polarities. Thus, it provides higher axial attraction for the shaft 221 and the magnetic body 24 to constrain the displacement of the shaft 221 in the axial direction and further reduce the abrasion of the shaft 221 and the noise generation of the motor 2. In addition, the first magnetic element 241 and the second magnetic element 242 of the present invention, which are disposed at the same side but with opponent polarities, also contribute to the reduction of magnetic leakage because the magnetic lines of the first magnetic element 241 and the second magnetic element 242 can form shorter closed paths and provide higher magnetic flux density to pass through the shaft 221. It further reduces the level of magnetic interference to other elements.

### The Second Embodiment

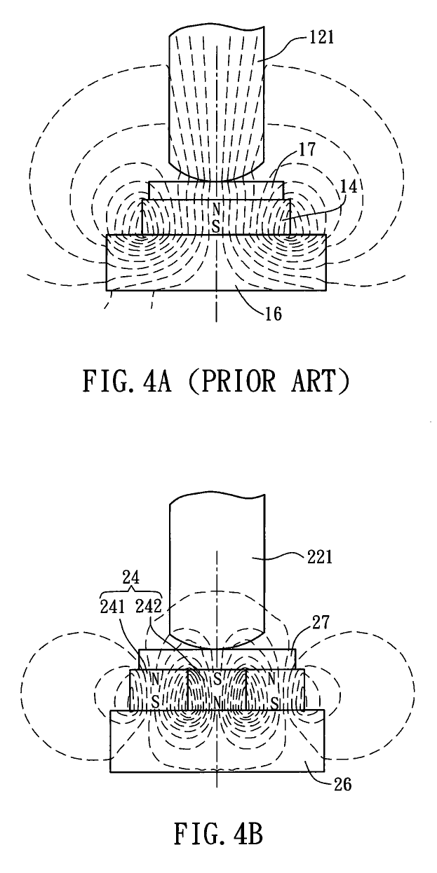

FIG. 5 is a cross-sectional figure of the motor 3 in accordance with the second embodiment of the present invention. The major difference between the present embodiment and the first embodiment is that the magnetic element 36 of the present embodiment is cup-shaped. In addition, the magnetic element is further disposed below the shaft 221 from bottom up, and connected to the base 35. Thus, the baffle 37, the first magnetic element 341 and the second magnetic element 342 are disposed in the cup-shaped receptacle of the magnetic element 35. The other technical characteristics of the present embodiment are identical to those of the first embodiment, and the detailed description thereof will be omitted.

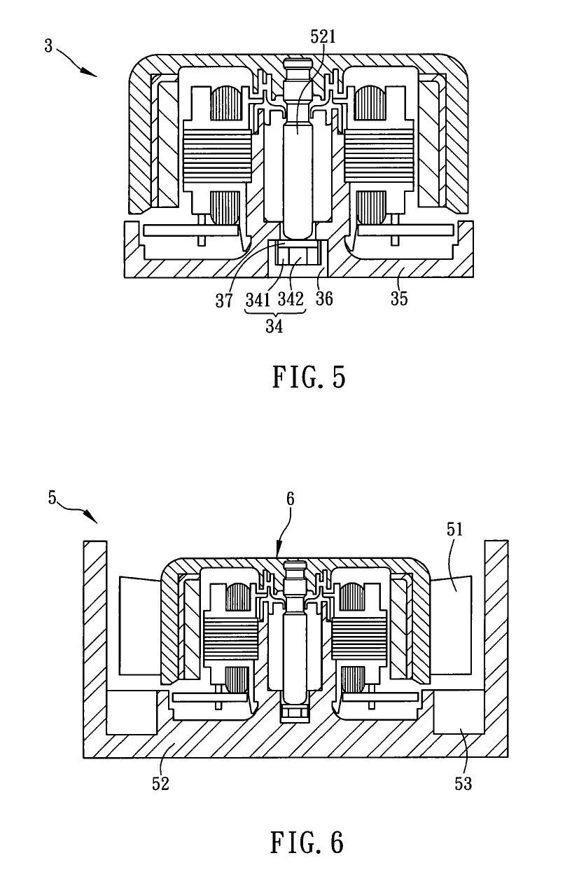

FIG. 6 is a cross-sectional figure of a fan 5 in accordance with the preferable embodiment of the present invention. The application of the fan 5 of the present invention is not limited. In addition, the appearance and the shape of the fan 5 of the present invention are not limited as well, and the structure of the fan 5 can be modified in accordance with its practical functions and fields.

The fan 5 includes a motor 6, a plurality of blades 51, a frame 52 and a stationary blade. The blades 51 are driven by the motor 6 to rotate and thereby generate air flow. The stationary blade 53 is connected to the frame 52 and the base of the motor. The motor 6 is, for example, an external-rotor motor or an internal-rotor motor. Herein, the external-rotor motor is taken for exemplary description. To be noted again, the motor 6 of the present embodiment is provided with all of the technical characteristics of the aforementioned motor 2, and the detail description thereof will be omitted.

In addition, the motors 2, 3 and 6 are not limited to any specific application, and can be applied in electronic equipment such as fans, optical disk drivers, hard disk drivers, optical devices or color wheels. The appearance and the shape of the motors 2, 3 and 6 of the present invention are not limited as well, and the structure of the motors 2, 3 and 6 can be modified in accordance with their practical functions and fields.

In summary, the present invention is provided with the magnetic body in the axial direction of the shaft of the motor. The magnetic body includes the first magnetic element and the second magnetic element. In accordance with one embodiment of the present invention, the first magnetic element is disposed around the second magnetic element, and the first magnetic element and the second magnetic element are disposed at the same side but with opponent polarities. Thus, the magnetic lines of the magnetic body form shorter closed paths and provide higher magnetic flux density to pass through the magnetic body and the shaft for providing the shaft and the magnetic body with higher axial attraction. It constrains the displacement of the shaft in axial direction, and further reduces the abrasion of the shaft and the noise generation of the motor and the fan. In addition, the first magnetic element and the second magnetic element of the motor and the fan in accordance with the present invention, which are disposed at the same side but with opponent polarities, also contribute to the reduction of magnetic leakage because the magnetic lines of the first magnetic element and the second magnetic element can form shorter closed paths and provide higher magnetic flux density. It further reduces the level of magnetic interference to other elements.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor, comprising:
a bearing structure;
a rotor structure comprising a shaft disposed on the bearing structure;
a stator structure disposed corresponding to the rotor structure; and
a magnetic body disposed corresponding to the shaft and the magnetic body comprising a first magnetic element and a second magnetic element, wherein the first magnetic element is disposed around the second magnetic element;
wherein the polarities of the first magnetic element and the second magnetic element disposed at the same side are opposite.

2. The motor of claim 1, wherein the rotor structure further comprises an iron housing and a hub connected to the iron housing and the shaft.

3. The motor of claim 2, wherein the hub is connected to the shaft by mounting, locking or adhesion.

4. The motor of claim 2, wherein the rotor structure further comprises a magnetic band disposed in and connected to the iron housing, and the magnetic band is disposed corresponding to the stator structure.

5. The motor of claim 4, wherein the material of each of the magnetic body and the magnetic band comprises ferrite, soft ferrite magnet, highly magnetic alloy, magnetic material or a combination thereof.

6. The motor of claim 4, wherein the magnetic band is a magnetic ring.

7. The motor of claim 1, further comprising:
a base comprising a bushing, wherein the shaft and the bearing structure are disposed in the bushing.

8. The motor of claim 7, further comprising:
a magnetic element connected to the base, wherein the magnetic body is disposed in the bushing and located at a side of the magnetic element, and the magnetic element is plate-shaped or cup-shaped.

9. The motor of claim 7, wherein the base and the bushing are integrally formed as one piece.

10. The motor of claim 1, further comprising:
a baffle disposed between the shaft and the magnetic body, wherein the magnetic body is disposed opposite to the shaft through the baffle.

11. The motor of claim 10, wherein the baffle is made of a non-magnetic material.

12. The motor of claim 1, wherein the first magnetic element is connected to the second magnetic element by sliding connection or tight connection.

13. The motor of claim 1, wherein the first magnetic element and the second magnetic element are disposed in concentric.

14. The motor of claim 1, wherein the first magnetic element and the second magnetic element are disposed in non-concentric.

15. The motor of claim 1, wherein each of the first magnetic element and the second magnetic element is circular-shaped, rectangular-shaped or triangular-shaped.

16. The motor of claim 1, wherein the first magnetic element is formed in the same shape as that of the second magnetic element.

17. The motor of claim 1, wherein the first magnetic element is formed in a shape different from that of the second magnetic element.

18. The motor of the claim 1, wherein the width of the first magnetic element is larger than the diameter of the shaft.

19. The motor of claim 1, wherein the width of the second magnetic element is 0.4 to 1 times as wide as the diameter of the shaft.

20. The motor of claim 1, which is an external-rotor motor or an internal-rotor motor.

21. A fan, comprising:
a motor comprising:
a bearing structure,
a rotor structure comprising a shaft disposed on the bearing structure,
a stator structure disposed corresponding to the rotor structure, and
a magnetic body disposed corresponding to the shaft and the magnetic body comprising a first magnetic element and a second element, wherein the first magnetic element is disposed around the second magnetic element; and
a plurality of blades disposed around the periphery of the rotor structure.
